(19) United States
(12) Patent Application Publication
(10) Pub. No.: US 2012/0299451 A1
(43) Pub. Date: Nov. 29, 2012

(54) Stator assembly for motor and motor including the same

(75) Inventor: Tae Young Choi, Yongin (KR)

(73) Assignee: SAMSUNG ELECTRO-MECHANICS CO., LTD., Suwon (KR)

(21) Appl. No.: 13/137,874

(22) Filed: Sep. 20, 2011

(30) Foreign Application Priority Data
May 23, 2011 (KR) 10-2011-0048494

(51) Int. Cl. H02K 5/22

(52) U.S. Cl. 310/68 D

(57) ABSTRACT

There are provided a stator assembly for a motor and a motor including the same. The stator assembly includes a base supporting a core having a coil wound therearound, the coil generating rotational driving force; a printed circuit board disposed between the core and the base and electrically connected to a lead wire of the coil; and a penetration part formed to penetrate through the base to thereby allow the printed circuit board to pass therethrough.

### CROSS-REFERENCE TO RELATED APPLICATIONS

This application claims the priority of Korean Patent Application No. 10-2011-0048494 filed on May 23, 2011, in the Korean Intellectual Property Office, the disclosure of which is incorporated herein by reference.

### BACKGROUND OF THE INVENTION

1. Field of the Invention

The present invention relates to a stator assembly for a motor and a motor including the same, and more particularly, to a stator assembly for a motor, capable of preventing disconnection between a lead wire of a coil and a base and easily closing an inner portion of a motor, and a motor including the same.

2. Description of the Related Art

A hard disk drive (HDD), a information storage device, reads data stored on a disk or writes data to the disk using a read/write head.

The hard disk drive requires a disk driving device capable of driving the disk. As the disk driving device, a small-sized motor is used.

Here, the motor rotating the disk, which is a device converting an electrical energy into a mechanical energy by using force applied to a conductor having a current flowing therein within a magnetic field, basically generates driving force rotating the disk by electromagnetic interaction between a magnet and a coil.

Further, in order to generate the driving force rotating the disk, the coil needs to be electrically connected to the outside and is supplied with current from the outside. To this end, a lead wire of the coil penetrates through the base member to be electrically connected to a printed circuit board (PCB) coupled to an outer surface of the base member.

Here, the lead wire of the coil is provided in plural due to characteristics of three phases and generates the driving force by the electromagnetic interaction with the magnet. However, since the plurality of lead wires of the coil respectively need to lead to the outside of a coil lead hole formed in the base member, a time required for a coil lead work increases, such that the coil lead work may be difficult to be performed.

In addition, even though the lead wire of the coil leads to the outside, a defect may be generated due to disconnection of the lead wire caused by contact between the lead wire and an inner peripheral surface of a coil lead part. This defect is directly associated with the performance and lifespan of a motor.

Further, the lead wire of the coil leads to the outside and the coil lead hole is sealed. However, a sealed area is wide, such that the amount of adhesive required for sealing increases accordingly. In addition, even though the sealing is performed, a defect may frequently be generated, such as imperfect sealing.

Therefore, research into a technology for preventing disconnection between the lead wire of the coil and the base simultaneously with allowing for an easy establishment of an electrical connection between the lead wire of the coil and the PCB for supplying power from the outside, thereby maximizing the performance and the lifespan of the motor has been urgently demanded.

### SUMMARY OF THE INVENTION

An aspect of the present invention provides a stator assembly for a motor that prevents disconnection between a lead wire of a coil and a base simultaneously with allowing for an easy establishment of an electrical connection between the lead wire of the coil and a printed circuit board for supplying power from the outside and easily closes an inner portion of a motor to thereby maximize a performance and a lifespan of a motor, and a motor including the same.

According to an aspect of the present invention, there is provided a stator assembly for a motor, the stator assembly including: a base supporting a core having a coil wound therearound, the coil generating rotational driving force; a printed circuit board disposed between the core and the base and electrically connected to a lead wire of the coil; and a penetration part formed to penetrate through the base to thereby allow the printed circuit board to pass therethrough.

The base may include a core support part protruding upwardly in an axial direction so as to support the core and a body part extended in an outer radial direction from an end portion of the core support part, and the penetration part may be formed in the body part.

The body part may include a seating part having the printed circuit board seated thereon and a bent part having the penetration part formed therein and bent from an end portion of the seating part such that the body part is stepped.

The stator assembly may further include a contact preventing part coupled to the base or the printed circuit board and including a lead part having the lead wire of the coil passing therethrough so as to prevent the lead wire of the coil from contacting the base.

The contact preventing part may include a coupled part coupled to the base or the printed circuit board and an extended part bent from an end portion of the coupled part such that the lead part is formed.

The stator assembly may further include a core coupling part coupled to the core support part to thereby seat the core thereon.

The stator assembly may further include a contact preventing part including a coupled part coupled to the base or the printed circuit board and an extended part bent from an end portion of the coupled part such that a lead part having the lead wire of the coil passing therethrough is formed, wherein the coupled part and the core coupling part are formed integrally with each other.

The lead wire of the coil and the printed circuit board may be electrically connected to each other by a soldering part, and an adhesive may be applied to an outer portion of the soldering part in order to prevent cold soldering in the soldering part.

The penetration part may be closed by an adhesive.

According to another aspect of the present invention, there is provided a motor including: the stator assembly for a motor as described above; a sleeve coupled to the base and supporting a shaft; and a hub rotating together with the shaft and including a magnet coupled thereto, the magnet generating rotational driving force by interaction between the magnet and the coil.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic cross-sectional view showing a motor including a stator assembly for a motor according to an embodiment of the present invention;

FIG. 2 is a schematic perspective view showing a base included in a stator assembly for a motor according to an embodiment of the present invention;

FIG. 3 is a schematic exploded perspective view showing a coupling relationship between a base and a printed circuit board included in a stator assembly for a motor according to an embodiment of the present invention;

FIG. 4 is a schematic cross-sectional view showing a motor including a stator assembly for a motor according to another embodiment of the present invention;

FIG. 5 is a schematic exploded perspective view showing a coupling relationship among a base, a printed circuit board, and a contact preventing part included in a stator assembly for a motor according to another embodiment of the present invention;

FIG. 6 is a schematic enlarged cross-sectional view showing a modified example of part A of FIG. 4;

FIG. 7 is a schematic cross-sectional view showing a motor including a stator assembly for a motor according to another embodiment of the present invention;

FIG. 8 is a schematic exploded perspective view showing a coupling relationship among a base, a printed circuit board, and a core coupling part included in a stator assembly for a motor according to another embodiment of the present invention;

FIG. 9 is a schematic cross-sectional view showing a motor including a stator assembly for a motor according to another embodiment of the present invention; and

FIG. 10 is an exploded perspective view schematically showing a coupling relationship among a base, a printed circuit board, and an integrally formed core coupling part and contact preventing part included in a stator assembly for a motor according to another embodiment of the present invention.

### DETAILED DESCRIPTION OF THE PREFERRED EMBODIMENT

Embodiments of the present invention will now be described in detail with reference to the accompanying drawings. However, it should be noted that the spirit of the present invention is not limited to the embodiments set forth herein and those skilled in the art and understanding the present invention could easily accomplish retrogressive inventions or other embodiments included in the spirit of the present invention by the addition, modification, and removal of components within the same spirit, but those are to be construed as being included in the spirit of the present invention.

Further, the same or like reference numerals will be used to designate the same or like components having similar functions throughout the drawings within the scope of the present invention.

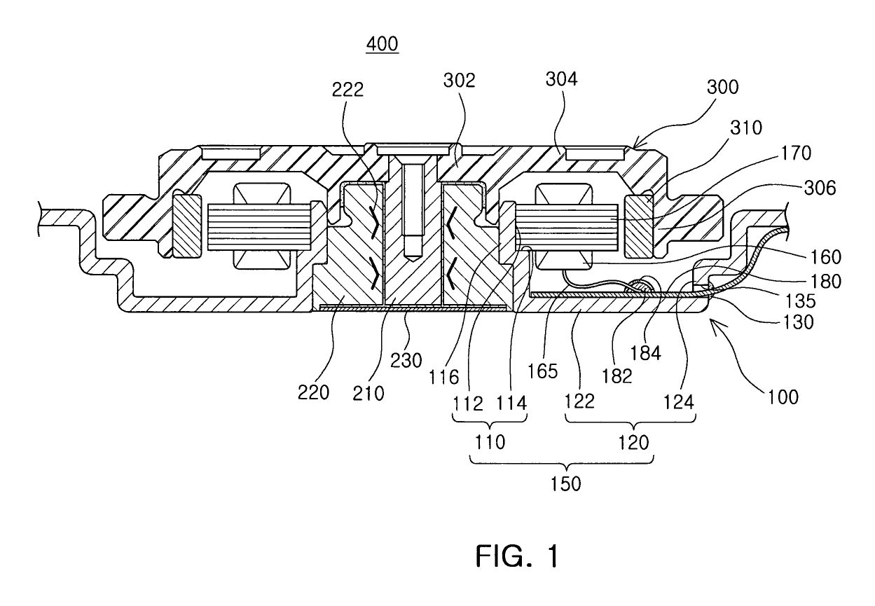

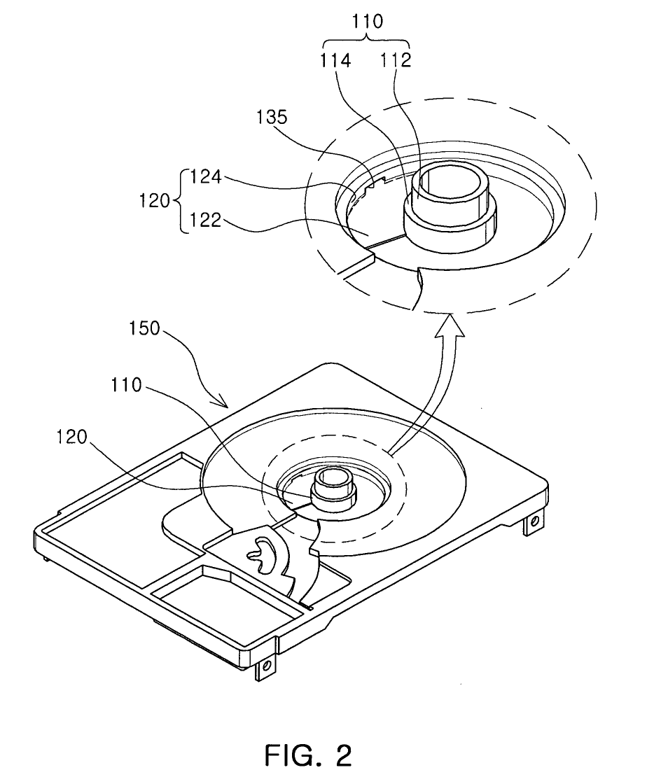

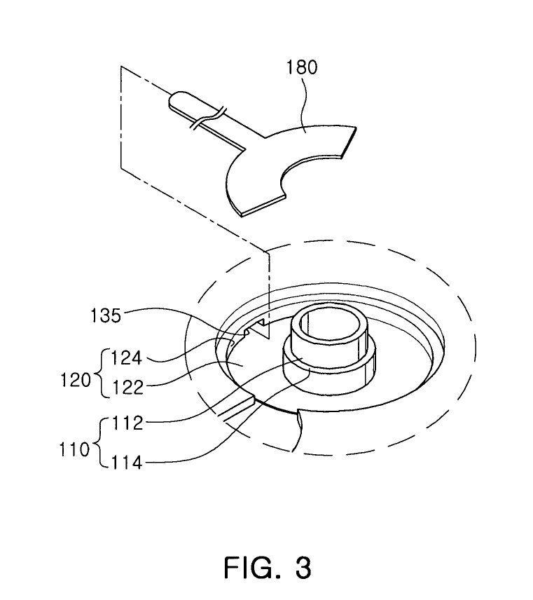

FIG. 1 is a schematic cross-sectional view showing a motor including a stator assembly for a motor according to an embodiment of the present invention; FIG. 2 is a schematic perspective view showing a base included in a stator assembly for a motor according to an embodiment of the present invention; and FIG. 3 is a schematic exploded perspective view showing a coupling relationship between a base and a printed circuit board included in a stator assembly for a motor according to an embodiment of the present invention.

Referring to FIGS. 1 through 3, a motor 400 including a stator assembly 100 for a motor according to an embodiment of the present invention may include a stator assembly 100 for a motor, (hereinafter, referred to as a stator assembly) including a base 150, a sleeve 220 supporting a shaft 210, and a hub 300 rotating together with the shaft 210.

Terms with respect to directions will be first defined.

As viewed in FIG. 1, an axial direction refers to a vertical direction based on the shaft 210, and an outer radial or inner radial direction refers to a direction towards an outer edge of the hub 300 based on the shaft 210 or a direction towards the center of the shaft 210 based on the outer edge of the hub 300.

Describing the outer radial or inner radial direction using components of the base 150, the outer radial direction refers to a direction toward a body part 120 based on a core support part 110 of the base 150 and the inner radial direction refers to an opposite direction to the outer radial direction.

The stator assembly 100 may include the base 150 supporting a core 170 having a coil 160 wound therearound and a printed circuit board 180 disposed between the core 170 and the base 150.

Here, the base 150 may be fixing member coupled to the sleeve 220 supporting the shaft 210, which is a shaft system of the motor 400 according to an embodiment of the present invention, and support the rotation of the hub 300 and the shaft 210, which are rotating members.

The entire shape of the base 150 may be manufactured by forming a basic configuration thereof through a process of pressing or forging a steel sheet such as a cold rolled steel sheet (SPCC, SPCE, or the like), a hot rolled steel sheet, or the like, and then performing a post-process such as a bending process, a cutting process, or the like thereupon.

However, a mold used for pressing or forging is formed to have a shape corresponding to that of a final base 150, whereby the base 150 may also be formed through a single process.

In this configuration, the base 150 may include the core support part 110 protruding upwardly in the axial direction such that the sleeve 220 and the core 170 having the coil 160 wound therearound are coupled thereto, and the sleeve 220 may be inserted into an insertion hole 116, which is an inner space of the core support part 110, to thereby be coupled to the base 150.

Here, as a method of coupling the base 150 and the sleeve 220 to each other, methods such as a bonding method, a welding method, a press-fitting method, or the like, may be used.

The core support part 110 may have a stepped outer peripheral surface and include a guide part 112 guiding the core 170 so as to be inserted into the base 150 and a seating part 114 supporting a bottom surface of the core 170.

In this configuration, the core support part 110 may have an inner peripheral surface having a shape corresponding to that of an outer peripheral surface of the sleeve 220, and have a uniform thickness due to characteristics of the pressing or forging method.

In addition, the base 150 may include the body part 120 extended in the outer radial direction from an end portion of the core support part 110, and the body part 120 may include a penetration part 135 formed to penetrate therethrough to thereby allow the printed circuit board 180 to pass therethrough.

In other words, the printed circuit board 180 may be disposed between the core 170 and the body part 120, and more specifically, be coupled to an upper surface of the body part 120.

In this configuration, the printed circuit board 180 may be electrically connected to a lead wire 165 of the coil by a soldering part 182 in such a manner that a power may be applied from the outside to the coil 160, and the soldering part 182 may include an adhesive 184 applied thereto.

The soldering part 182 is enclosed by the adhesive 184, whereby a defect due to cold soldering of a solder may be prevented and reliability in the soldering part 182 may be secured.

In addition, the printed circuit board 180 may pass through the penetration part 135 to thereby lead to the outside of the body part 120. As a result, the printed circuit board 180 may be coupled to a bottom surface of the body part 120 to thereby be electrically connected to an external device.

Here, describing a specific position at which the penetration part 135 is formed, the penetration part 135 may be formed in a bent part 124 of the body part 120.

The bent part 124 may be bent such that the body part 120 is stepped from an end portion of the seating part 122 including the printed circuit board 180 seated thereon, and the penetration part 135 may penetrate through the body part 120 to thereby allow inner and outer portions of the body part 120 to be in communication with each other.

The penetration part 135 may be closed by an adhesive 130 after the printed circuit board 180 passes therethrough. Air tightness of the motor 400 according to an embodiment of the present invention may be maintained by the adhesive 130.

Here, the printed circuit board 180 may have a shape corresponding to that of the seating part 122; however, it may also have a shape changeable according to the intention of a designer as long as it may be coupled to a predetermined area of the seating part 122.

In the stator assembly 100 according to an embodiment of the present invention, the printed circuit board 180 is coupled to an upper surface of the seating part 122 of the body part 120 to thereby be electrically connected to the lead wire 165 of the coil by the soldering part 182, such that a hole used to lead the lead wire 165 of the coil to the outside of the base 150 may not be required.

Therefore, a disconnection defect due to contact between the lead wire of the coil and the base, capable of being generated by a hole, or the like, required for leading the lead wire of the coil because of the printed circuit board disposed on the bottom surface of the base as in the case according to the related art may be previously prevented.

A process of manufacturing the hole for leading the lead wire of the coil is not required, whereby productivity and production efficiency may be improved.

Furthermore, according to the present invention, an insulating member, or the like, which is used to prevent disconnection between the lead wire of the coil and the base may not required, whereby production costs may be minimized.

As a result, in the stator assembly 100 according to an embodiment of the present invention, the printed circuit board 180 is coupled to the upper surface of the seating part 122, whereby an establishment of an electrical connection between the lead wire 165 of the coil and the printed circuit board 180 for supplying power may be easily performed without using the hole for leading the coil 160.

In addition, the hole for leading the lead wire of the coil according to the related art is closed by an adhesive for air tightness. However, according to the present invention, the penetration part 135 having a size relatively smaller than that of the hole for leading the lead wire of the coil according to the related art is closed to effectively close the inner portion of the motor 400 according to the present invention, whereby air tightness may be maximized.

The shaft 210, which is a rotating member coupled to the hub 300 to thereby rotate together with the hub 300, may be supported by the sleeve 220.

In this configuration, the sleeve 220 may support the shaft 210 such that an upper end of the shaft 210 protrudes upwardly in the axial direction, and may be formed by forging Cu or Al or sintering a Cu—Fe based alloy powder or a SUS-based power.

The shaft 210 is inserted into a shaft hole of the sleeve 220, having a micro clearance therebetween. The micro clearance is filled with oil, and the rotation of the hub 300 may be more smoothly supported by a radial dynamic pressure part 222 formed in at least one of an outer circumferential surface of the shaft 210 and an inner circumferential surface of the sleeve 220.

The radial dynamic pressure part 222 may generate pressure so as to be deflected toward one side at the time of rotation of the shaft 210 and may have any one of a herringbone shape, a spiral shape, and a helical shape.

However, the radial dynamic pressure part 222 is not limited to having the above-mentioned shape but may have any shape, as long as a radial dynamic pressure may be generated in a rotating member including the shaft 210 and the hub 300 at the time of rotation of the rotating member. In addition, the number of radial dynamic pressure parts is not limited.

Here, the sleeve 220 may include a base cover 230 coupled thereto at a lower portion thereof in the axial direction while having a clearance therebetween, the clearance receiving the oil therein.

The base cover 230 may receive oil in the clearance between the base cover 230 and the sleeve 230 to thereby serve in itself as a bearing supporting a lower surface of the shaft 210.

In addition, the oil may be continuously filled in the clearance between the shaft 210 and the sleeve 220, in a clearance between the hub 300 and the sleeve 220 and in a clearance between the base cover 230, the shaft 210 and the sleeve 220, whereby a full-fill structure may be entirely formed.

The hub 300 may be a rotating structure rotatably provided with respect to a fixing member including the base 150 and include an annular ring-shaped magnet 310 formed on an inner circumference surface thereof, the annular ring-shaped magnet 310 corresponding to the core 170, while having a predetermined interval therebetween.

In addition, the hub 300 may include a first cylindrical wall part 302 fixed to the upper end of the shaft 210, a disk part 304 extended in the outer radial direction from an end portion of the first cylindrical wall part 302, and a second cylindrical wall part 306 protruding downwardly in an outer radial direction of the disk part 304 from an end portion of the disk part 304. Here, the second cylindrical wall part 306 may include the magnet 310 coupled to an inner peripheral surface thereof.

Here, rotational driving force of the motor 400 according to an embodiment of the present invention may be obtained by interaction between the magnet 310 and the coil 160 wound around the core 170.

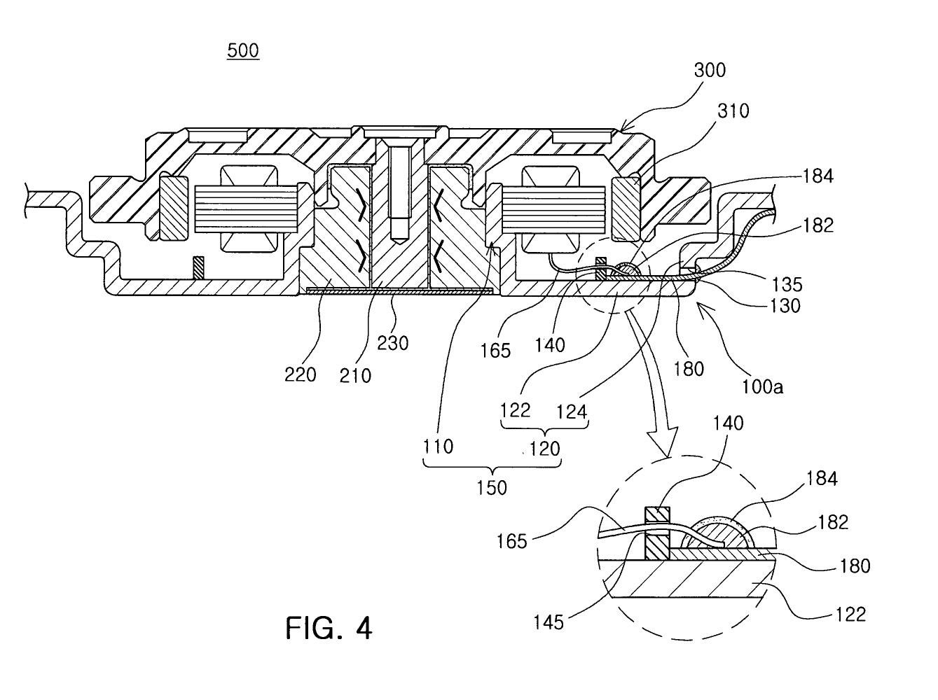

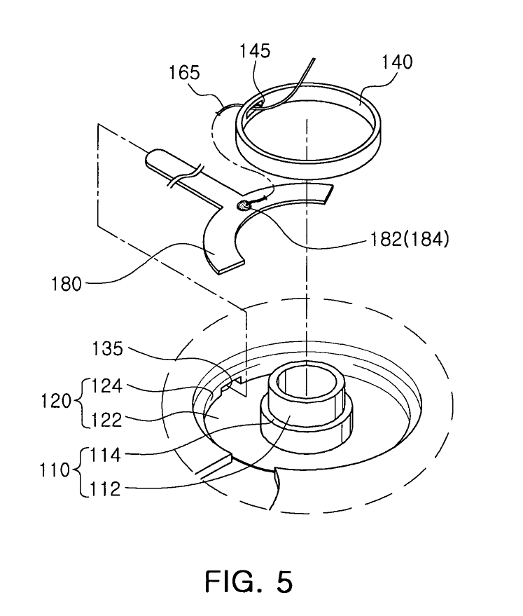

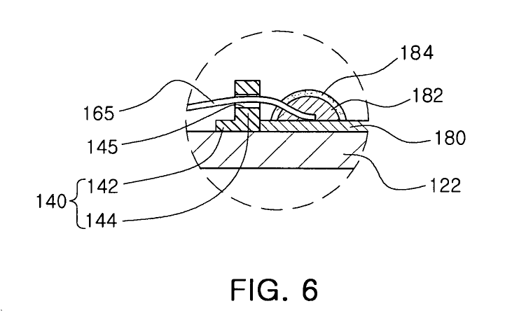

FIG. 4 is a schematic cross-sectional view showing a motor including a stator assembly for a motor according to another embodiment of the present invention; FIG. 5 is a schematic exploded perspective view showing a coupling relationship among a base, a printed circuit board, and a contact preventing part included in a stator assembly for a motor according to another embodiment of the present invention; and FIG. 6 is a schematic enlarged cross-sectional view showing a modified example of part A of FIG. 4.

Referring to FIGS. 4 and 5, a motor 500 including a stator assembly 100a according to another embodiment of the present invention is the same as the motor 400 including the stator assembly 100 according to the embodiment of the present invention described with reference to FIGS. 1 through 3 except for a contact preventing part 140. Therefore, a description, except for that of the contact preventing part 140, will be omitted.

The contact preventing part 140 may include a lead part 145 coupled to an upper surface of the body part 120 of the base 150 to thereby allow at least one lead wire 165 of the coil to pass therethrough.

The contact preventing part 140 may be disposed inside a portion at which the lead wire 165 of the coil is soldered to the printed circuit board 180 in a radial direction to thereby allow for fixing the lead wire 165 of the coil.

That is, the contact preventing part 140 may allow the lead wire 165 of the coil to pass through the lead part 145 formed therein to thereby prevent the lead wire 165 of the coil from contacting the base 150 or other components.

Here, the contact preventing part 140 may be formed to have a circumferential shape along an upper surface of the seating part 122 of the body part 120. However, the contact preventing part 140 is not limited to having the circumferential shape but may have an arc shape, being a portion of a circumference, limited to only an area in which the lead wire 165 of the coil is present.

In addition, the contact preventing part 140 is not limited to being coupled to the upper surface of the seating part 122 of the body part 120 but may be coupled to an upper surface of the printed circuit board 180;

That is, the contact preventing part 140 may be coupled to any position, as long as contact between the lead wire 165 of the coil and other components may be prevented.

Referring to FIG. 6, the contact preventing part 140 may include a coupled part 142 coupled to an upper surface of the base 150, that is, the upper surface of the seating part 122 of the body part 120 and an extended part 144 may be formed to be bent from an end portion of the coupled part 142.

The contact preventing part 140 may have an increased coupling area between the contact preventing part 140 and the base 150 due to the coupled part 142 to thereby allow for an increase in unmating force and to minimize a possibility of being separated from the base 150, even in the case that an external impact is applied thereto.

In addition, the coupled part 142 may be formed to have a circumferential shape along the upper surface of the seating part 122 of the body part 120. However, the coupled part 142 is not limited to having the circumferential shape but may have an arc shape, being a portion of a circumference, limited to only an area in which the lead wire 165 of the coil is present.

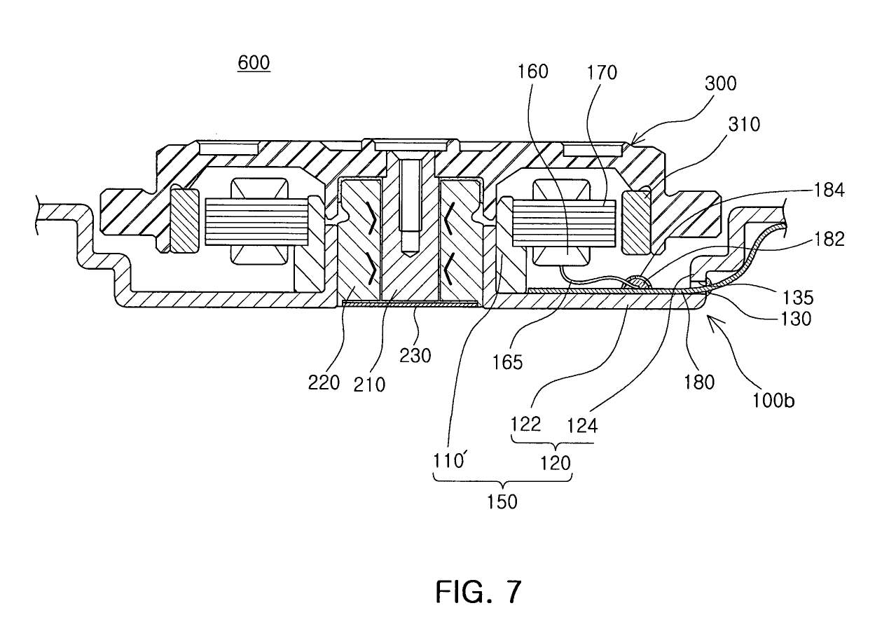

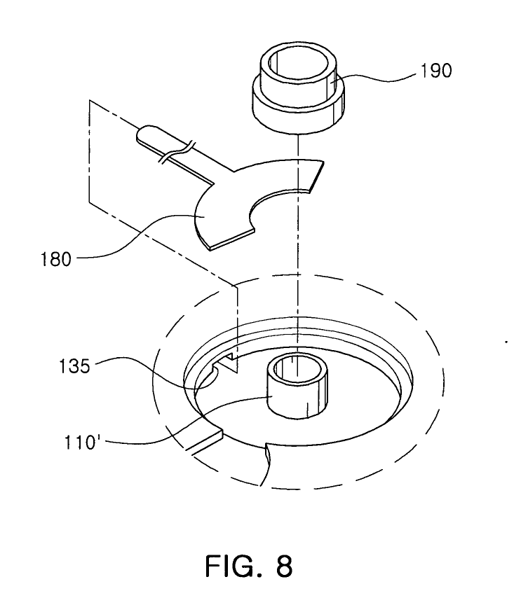

FIG. 7 is a schematic cross-sectional view showing a motor including a stator assembly for a motor according to another embodiment of the present invention; and FIG. 8 is a schematic exploded perspective view showing a coupling relationship among a base, a printed circuit board, and a core coupling part included in a stator assembly for a motor according to another embodiment of the present invention.

Referring to FIGS. 7 and 8, a motor 600 including a stator assembly 100b according to another embodiment of the present invention is the same as the motor 400 including the stator assembly 100 according to the embodiment of the present invention described with reference to FIGS. 1 through 3, except for a core support part 110′ and a core coupling part 190 of the base 150. Therefore, a description except for those of the core support part 110′ and the core coupling part 190 will be omitted.

The core support part 110′ may protrude upwardly in the axial direction in such a manner that the sleeve 220 supporting the shaft 210 is coupled to an inner peripheral surface thereof and indirectly support the core 170 having the coil 160 wound therearound.

That is, in order to couple the core 170 and the core support part 110′ to each other, the core coupling part 190 may be disposed between the core 170 and the core support part 110′.

In other words, the core coupling part 190 may be coupled to an outer peripheral surface of the core support part 110′ having a constant diameter, to thereby allow the core 170 to be inserted thereinto and seated thereon.

That is, the core coupling part 190, which is a member facilitating the coupling between the core support part 110′ and the core 170 having the same thickness due to characteristics of a method of manufacturing the base 150 according to an embodiment of the present invention, that is, a pressing or forging method, may be separately manufactured to thereby be coupled to the core support part 110′.

The core coupling part 190 may have a stepped outer peripheral surface to thereby have the core 170 inserted thereinto and support a bottom surface of the core 170. As a method of coupling the core coupling part 190 and the core support part 110′ to each other, a bonding method, a welding method, and a press-fitting method may be used.

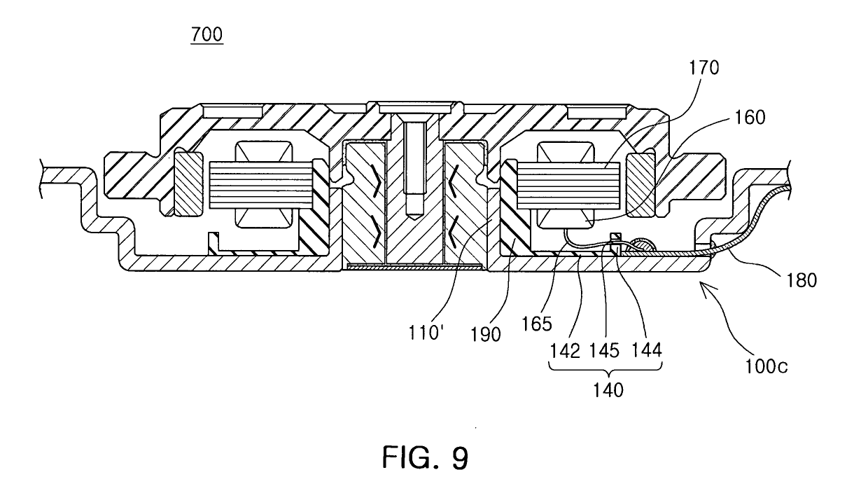

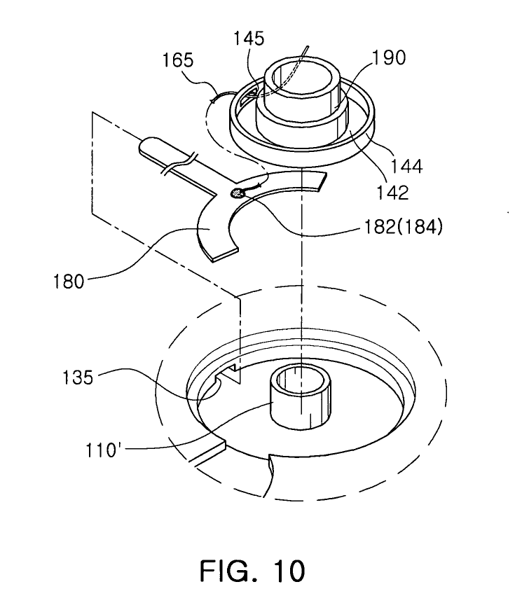

FIG. 9 is a schematic cross-sectional view showing a motor including a stator assembly for a motor according to another embodiment of the present invention; and FIG. 10 is an exploded perspective view schematically showing a coupling relationship among a base, a printed circuit board, and an integrally formed core coupling part and contact preventing part included in a stator assembly for a motor according to another embodiment of the present invention.

Referring to FIGS. 9 and 10, in a motor 700 including a stator assembly 100c for a motor according to another embodiment of the present invention, the coupled part 142 and the core coupling part 190 may be formed integrally with each other.

In other words, the coupling part 142 of the contact preventing part 140 described with reference to FIGS. 4 through 6 may be extended toward the core support part 110′ in the inner radial direction to thereby be formed integrally with the core coupling part 190 described with reference to FIG. 6.

Therefore, the coupling between the core 170 and the core support part 110′ may be easily performed by a single member and contact between the lead wire 165 of the coil and other components may be previously prevented due to the lead part 145.

Through the embodiments as described above, in the motors 400, 500, 600, and 700 including the stator assemblies 100, 100a, 100b, and 100c according to the embodiments of the present invention, the lead wire 165 of the coil is electrically connected to the printed circuit board 180 disposed on the upper surface of the base 150, whereby contact between the lead wire 165 of the coil and the base 150, or the like, may be prevented.

In addition, the penetration part 135 is formed in the base 150 in order to lead the printed circuit board 180 to the outside of the base 150 and is closed by the adhesive 130, whereby air tightness may be maintained.

Further, contact between the lead wire 165 of the coil and the base 150, or the like, may be effectively prevented by the contact preventing part 140 coupled to the base 150 or the printed circuit board 180.

As set forth above, with the stator assembly for a motor and the motor including the same according to the embodiments of the present invention, an establishment of electrical connection between the lead wire of the coil and the printed circuit board for supplying power may be easily performed and the disconnection between the lead wire of the coil and the base may be prevented.

In addition, the inner portion of the motor may be easily closed, whereby the performance and the lifespan of the motor may be improved.

While the present invention has been shown and described in connection with the embodiments, it will be apparent to those skilled in the art that modifications and variations can be made without departing from the spirit and scope of the invention as defined by the appended claims.

What is claimed is:

1. A stator assembly for a motor, the stator assembly comprising:
a base supporting a core having a coil wound therearound, the coil generating rotational driving force;
a printed circuit board disposed between the core and the base and electrically connected to a lead wire of the coil; and
a penetration part formed to penetrate through the base to thereby allow the printed circuit board to pass therethrough.

2. The stator assembly of claim 1, wherein the base includes a core support part protruding upwardly in an axial direction so as to support the core and a body part extended in an outer radial direction from an end portion of the core support part, and
the penetration part is formed in the body part.

3. The stator assembly of claim 2, wherein the body part includes a seating part having the printed circuit board seated thereon and a bent part having the penetration part formed therein and bent from an end portion of the seating part such that the body part is stepped.

4. The stator assembly of claim 1, further comprising a contact preventing part coupled to the base or the printed circuit board and including a lead part having the lead wire of the coil passing therethrough so as to prevent the lead wire of the coil from contacting the base.

5. The stator assembly of claim 4, wherein the contact preventing part includes a coupled part coupled to the base or the printed circuit board and an extended part bent from an end portion of the coupled part such that the lead part is formed.

6. The stator assembly of claim 1, further comprising a core coupling part coupled to the core support part to thereby seat the core thereon.

7. The stator assembly of claim 6, further comprising a contact preventing part including a coupled part coupled to the base or the printed circuit board and an extended part bent from an end portion of the coupled part such that a lead part having the lead wire of the coil passing therethrough is formed,
wherein the coupled part and the core coupling part are formed integrally with each other.

8. The stator assembly of claim 1, wherein the lead wire of the coil and the printed circuit board are electrically connected to each other by a soldering part, and an adhesive is applied to an outer portion of the soldering part in order to prevent cold soldering in the soldering part.

9. The stator assembly of claim 1, wherein the penetration part is closed by an adhesive.

10. A motor comprising:
the stator assembly for a motor of claim 1;
a sleeve coupled to the base and supporting a shaft; and
a hub rotating together with the shaft and including a magnet coupled thereto, the magnet generating rotational driving force by interaction between the magnet and the coil.
